(19) United States
(12) Patent Application Publication
(10) Pub. No.: US 2020/0242650 A1
(43) Pub. Date: Jul. 30, 2020

(54) SYSTEMS AND METHODS FOR PROMPTING USERS ABOUT PURCHASE ITEMS BASED ON LIKELIHOOD OF PURCHASE OF ITEMS

(71) Applicant: Toshiba Global Commerce Solutions Holdings Corporation, Tokyo (JP)

(72) Inventors: James Hawk, Research Triangle Park, NC (US); Jeff Hawkins, Research Triangle Park, NC (US); Paul Lindsey, Research Triangle Park, NC (US); Sergio Toscano Lomeli, Zapopan (MX)

(21) Appl. No.: 16/260,840

(22) Filed: Jan. 29, 2019

(51) Int. Cl. G06Q 30/02; G06F 9/54

(52) U.S. Cl. CPC G06Q 30/0223; G06F 9/542; G06Q 30/0238

(57) ABSTRACT

Systems and methods for prompting users about purchase items based on likelihood of purchase of items are disclosed. According to an aspect, a method may be implemented at a system for conducting purchase transactions. The method includes identifying items selected for purchase. Further, the method includes determining a likelihood of purchase of an item together with one or more of the other items. The method also includes presenting identification of the item based on the determined likelihood of purchase of the item. Further, this method may include updating a model or rules based on shopper feedback as to whether a particular item was correctly identified as an undesired item.

### TECHNICAL FIELD

The presently disclosed subject matter relates generally to retail systems. Particularly, the presently disclosed subject matter relates to systems and methods for prompting users about purchase items based on likelihood of purchase of items.

### BACKGROUND

In retail environments, such as grocery stores and other “brick and mortar” stores, customers typically shop within a store and subsequently proceed to checkout for purchase of items at a point of sale (POS) terminal. The POS terminal may operate to conduct a self-checkout purchase transaction with the customer, or the POS terminal may operate to conduct a purchase transaction with the customer with assistance of store personnel. Such purchase transactions typically involve scanning a bar code of each item for purchase by the customer in order to calculate and display a total amount owed by the customer for the products. Subsequently, a purchase transaction for the customer may be completed after entry of payment information by the customer or store personnel.

In some instances, customers may shop and bring an item to the checkout area that he or she did not intend to purchase. This may be a mistake on the customer's part, because it was included with several other similar items that the customer intended to purchase. For example, when buying many of the same item, a similar item may be inadvertently picked up by the customer. As an example, in hardware stores, a bin containing ⅜″-16 bolts may also have ¾″-24 bolts in it. This may be due to errors by stocking clerks or due to shoppers putting items back in the wrong bin. In any case, a customer may intend to purchase 10 of one of the types of bolts; however, the customer may mistakenly include one or more of the wrong bolts in the group. The customer may subsequently proceed to checkout and purchase the wrong bolt. Later, the customer would likely determine that the wrong bolt was purchased and may need to return to the store to return the item. This can lead to frustration for the customer and additional work for store personnel if the item is returned.

In view of the foregoing, there is a need for improved POS systems and techniques to avoid customer purchase of unintended items.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a purchase transaction system or POS system according to embodiments of the present disclosure;

FIG. 2 is a flow chart of an example method for determining a likelihood of intended purchase of items and for presenting related information to users in accordance with embodiments of the present disclosure;

FIG. 3 is a flow chart of an example method for providing a purchase model to determine a likelihood of intended purchase of items and for prompting users about whether a purchase was intended in accordance with embodiments of the present disclosure;

FIG. 4 is a flow chart of another example for determining a likelihood of intended purchase of items and for presenting related information to users in accordance with embodiments of the present disclosure;

FIG. 5 is a flow chart of an example method for updating a purchase model based on return of an item to a retail store in accordance with embodiments of the present disclosure; and

FIG. 6 is a perspective view of an example checkout area with a POS terminal for determining a likelihood of intended purchase of items and for presenting related information to users in accordance with embodiments of the present disclosure.

### SUMMARY

The presently disclosed subject matter includes systems and methods for prompting users about purchase items based on likelihood of purchase of items. According to an aspect, a method may be implemented at a system for conducting purchase transactions. For example, the method may be implemented at a POS terminal. The method includes identifying items selected for purchase. Further, the method includes determining a likelihood of purchase of an item together with one or more of the other items. The method also includes presenting identification of the item based on the determined likelihood of purchase of the item.

According to another aspect, a method includes providing a purchase model that indicates identifiers of items for purchase and a likelihood estimate of the identified items being purchased together in a purchase transaction. Further, the method includes using the purchase model to prompt a user about whether purchase was intended for one or more of the items.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to denote different aspects of methods employed, the term should not be interpreted as implying any particular order among or between various steps herein disclosed unless and except when the order of individual steps is explicitly described.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

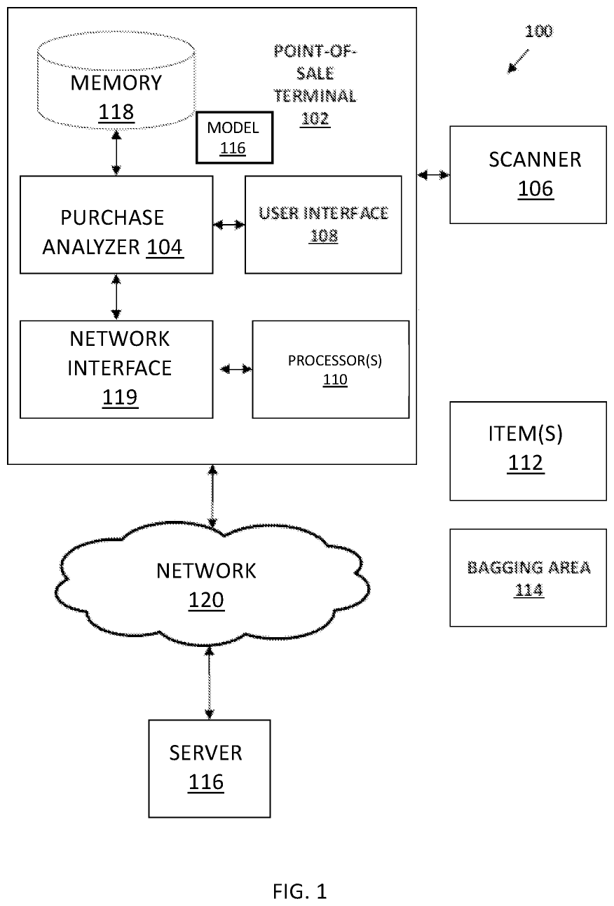

FIG. 1 illustrates a block diagram of a purchase transaction system or POS system 100 according to embodiments of the present disclosure. Referring to FIG. 1, the system 100 may be implemented in whole or in part in any suitable environment for conducting purchase transactions. For example, the system 100 may be implemented in any retail store (e.g., a hardware store or grocery store) that can use a point-of-sale (POS) terminal. The system 100 may include a POS terminal 102 that may include a purchase analyzer 104, such as a POS application. The POS terminal 102 may be communicatively coupled to a scanner 106, and a user interface 108. The purchase analyzer 104 may be an application that executes on one or more processors 110 of the POS terminal 102. The processor(s) 110 may be, for example, a dual processor which includes a graphical processing unit (GPU) for rendering multiple different static images and/or pixel frames of video data. The POS terminal 102 may include any suitable hardware, software, and/or firmware for implementing functions and processes in accordance with embodiments of the present disclosure. The system 100 may include any number of transaction terminals, and only one transaction terminal is shown in FIG. 1 for convenience of illustration.

The scanner 106 may be capable of reading a machine-readable image representing data from one or more item(s) 112 for purchase. The scanner 106 may be a handheld device that can be passed over a barcode (e.g., a universal product code (UPC) or any other machine-readable image) on one of the items 112 or may be built into a counter or platform whereby products are passed over the scanner. Further, the scanner 106 may read data from purchase items and transmit the data to the transaction terminal 102 via, for example, a wireless or wireline connection. In an example, the machine-readable image on the item(s) 112 may represent identification of the purchase item. Identification of the item may alternatively be provided to the transaction terminal by, for example, a user entering an identifier, such as a number, representing the item. The identification may be used for accessing data associated with the purchase item, such as, but not limited to, information for determining a category or pricing of the item 112. In a purchase transaction, the identifications of multiple items may be obtained in this way, and the identifications may be communicated to the purchase analyzer 104 as items are scanned.

The user interface 108 may include a keyboard device or touch display that enables a shopper or retail personnel, such as a cashier, to input information and to be presented with information or graphics related to a purchase transaction. For example, a shopper may input account and payment information for processing by the POS terminal 102. The user interface 108 may include a scanning device with a keypad for reading a shopper's financial card (e.g., credit card or debit card) including account number. The user interface 108 may be rendered on a display (not shown) attached to the POS terminal 102. The keypad device on the financial card scanning device may enable a shopper to enter a personal identification number (PIN) if using a debit card or other financial card that requires the PIN be entered. The user interface 108 may include the display for displaying purchase and transaction information to the shopper. For example, the user interface 108 may be a touchscreen display for displaying text and graphics and for receiving user input. The user interface 108 may be communicatively coupled to the POS terminal 102 via wireless or wireline elements.

The scanner 106 may be configured to read a machine-readable image representing an identifier of an item. The bagging area 114 may be an area associated with the POS terminal 102 in which the user bags or packages the item 112 when conducting a purchasing transaction or activity. For example, retail personnel or a customer may bag items at the bagging area 114. The scanner 106 may be used to scan the barcode of the coupon. The purchase analyzer 104 may determine whether the identifier corresponds to an item for purchase.

The functionality of the purchase analyzer 104 may be partially or entirely implemented at a remote computing device, such as server 116. The POS terminal 102 may communicatively connect to the server 116 via a network interface 118 and network 120, such as a local area network and/or the Internet.

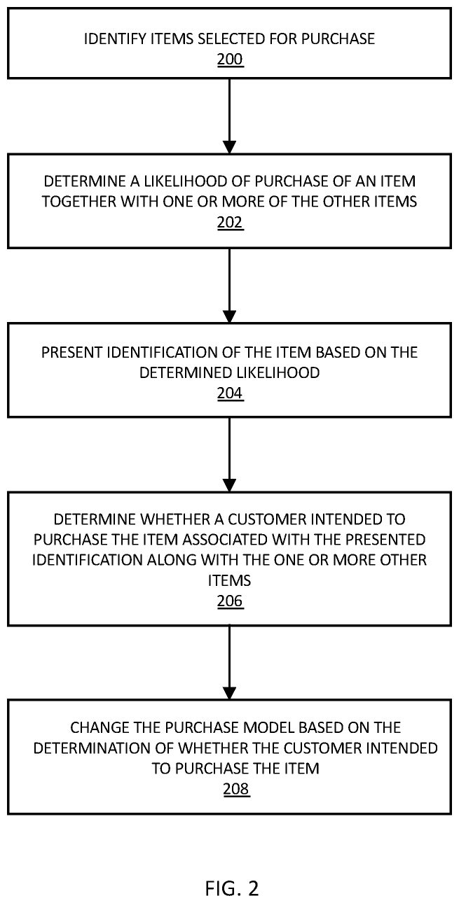

FIG. 2 illustrates a flow chart of an example method for determining a likelihood of intended purchase of items and for presenting related information to users in accordance with embodiments of the present disclosure. The method of FIG. 2 is described by example as being implemented by the system 100 shown in FIG. 1, although it should be understood that the method may alternative be implemented by any other suitable POS system. In particular for example, the purchase analyzer 104 of the POS terminal 102 is described as implementing the steps of the method; however, any suitable hardware, software, firmware or combinations thereof as components of a computing device or multiple computing device may implements the steps of the method or the functionality described herein for the purchase analyzer 104.

Referring to FIG. 2, the method includes identifying 200 items selected for purchase. For example, at the POS terminal 102 shown in FIG. 1, a purchase transaction for multiple items may be initiated. The cashier attending the POS terminal 102 may initiate the purchase transaction by use of the user interface 108 when a customer arrives at the POS terminal 102 for checkout and assistance by the cashier. Alternatively, for example, the POS terminal 102 may be a self-checkout purchase terminal, and the customer may initiate the purchase transaction at the POS terminal 102 by suitably interacting with the user interface 108, such as by touching an icon on a display screen for initiating the purchase transaction. Further, the customer or cashier may use the scanner 106 to scan the bar codes of multiple items. The scanner 106 may communicate identifiers (e.g., universal product code (UPC)) for the items to the purchase analyzer 104. Thereby identification information for the items selected for purchase by the customer is received at the purchase analyzer 104. Alternatively, for example, a cashier or customer may use the user interface 108 to manually enter a UPC or (stock keeping unit) SKU information into the user interface 108 for identifying one or more of the items.

The method of FIG. 2 includes determining 202 a likelihood of purchase of an item together with one or more of the other items. Continuing the aforementioned example, the purchase analyzer 104 may determine a likelihood of a purchase of one of the scanned items together with one or more of the other scanned items. In an example, the purchase analyzer 104 may access a purchase model 116 that indicates item identifiers and a likelihood estimate of items being purchased together. In an example, the purchase model 116 may be stored in memory 118 along with a database that contains all or at least some identifiers for each item in a retail store. Each item identified in the database may be associated with another identified item and include a likelihood estimate of the items being purchased together. For example, in a grocery store setting, multiple varieties of apples may be sold. The purchase model 116 and database may indicate that there is a 20% likelihood of 2 particular varieties of apples being sold together. The purchase model 116 may provide a direct comparison between items and indicate the likelihood of the 2 items being sold together. In this example, the 2 different varieties of apples may be scanned in a single transaction for a customer. The purchase analyzer 104 may subsequently access the purchase model 116 and database to determine that there is the 20% likelihood of 2 particular varieties of apples being sold together.

Another example is exterior decking screws, 5/4″ pressure treated lumber, and 2″×8″ untreated lumber within a single transaction. A purchase model in accordance with the present disclosure may identify the anomaly of 2″×8″ lumber being interior use only and determine a 30% likelihood that these items may be used for the same construction project. Hence, it may be incorrectly selected by the customer, and therefore the customer may be notified it in accordance with embodiments of the present disclosure.

The method of FIG. 2 includes presenting 204 identification of the item based on the determined likelihood of purchase of item. Continuing the aforementioned example, the purchase analyzer 104 may determine whether the determined likelihood of purchase of the items together with one or more of the other items meets a predetermined threshold. Returning to the example of a 20% likelihood of 2 particular varieties of apples being sold together, the purchase analyzer 104 may provide a notification to a customer and/or cashier in response to the purchase analyzer 104 determining that the 20% is less than a predetermined threshold of 30%. In other words, the purchase analyzer 104 in this example provides a notification to a customer and/or cashier in response to a determination that the likelihood of 2 items identified for purchase in a single transaction is less than 30%. The purchase analyzer 104 may use the user interface 108 to provide the notification such as by displaying a notification.

The method of FIG. 2 includes determining 206 whether a customer intended to purchase the item associated with the presented identification along with the one or more other items. Continuing the aforementioned example, the purchase analyzer 104 may control the user interface 108 to prompt the customer to consider whether the customer meant to purchase the 2 varieties of apples. Further, the customer may interact with the user interface 108 to indicate whether he or she intended to purchase the apples together. For example, the customer may touch a display of the user interface to indicate “YES” or “NO” the apples were intended to be purchased together. The purchase analyzer 104 may remove an item if the customer indicates that it was not intended to be purchased. Conversely, the item may stay in a purchase transaction list if the customer indicated that it was intended to be purchased.

The method of FIG. 2 includes changing 208 the purchase model based on the determination of whether the customer intended to purchase the item. Continuing the aforementioned example, the purchase analyzer 104 may update the purchase model 116 and database based on whether the customer intended to purchase the item. Returning to the example of apples, the purchase analyzer 104 may increase the likelihood measure between the 2 varieties of apples in response to the customer indicating that the apples were intended to be purchased together. Conversely, the purchase analyzer 104 may decrease the likelihood measure between the 2 varieties of apples in response to the customer indicating that the apples were not intended to be purchased together. In this way, the purchase model 116 can be improved and made more accurate for future purchases. In this way, processing by the purchase analyzer 104 and/or other hardware for customer queries and likelihood determinations may be made more efficient for further purchase transactions.

In accordance with embodiments, two accumulators may be used be present in the purchase model 116 to track each time the incorrect item was correctly identified (C) and each time the item was erroneously identified (E). Each rule may have unique accumulators, C and E. Across the store or across the entire retail's enterprise, these statistics can be used to recalculate the accuracy by a ratio C/E. The specific rule in the purchase model 116 that flagged this potential mismatch of items can be updated with C/E to refine the rule. Further, once C/E is below a threshold (e.g., 0.8) the rule is no longer used. The frequency of update may be real-time, at specific time intervals, or the result of other system events, such as after 100 transactions.

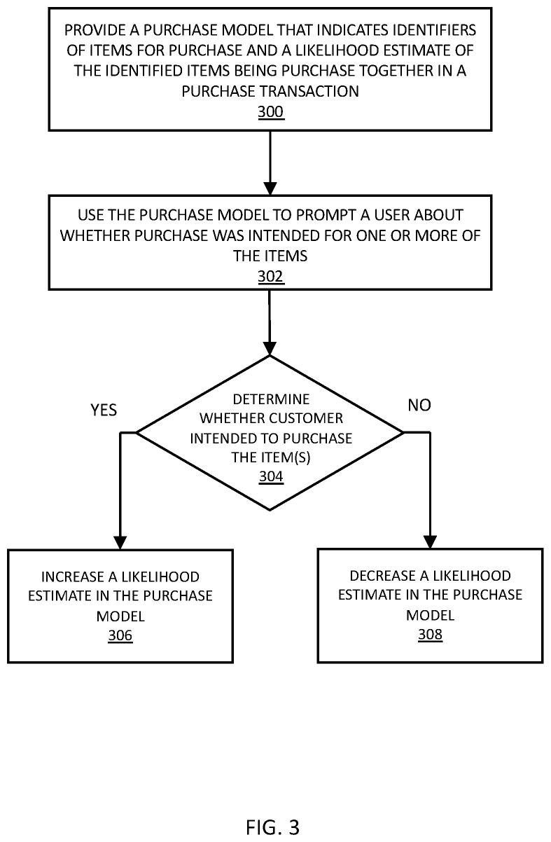

In accordance with embodiments of the present disclosure, FIG. 3 illustrates a flow chart of an example method for providing a purchase model to determine a likelihood of intended purchase of items and for prompting users about whether a purchase was intended. The method of FIG. 3 is described by example as being implemented by the system 100 shown in FIG. 1, although it should be understood that the method may alternative be implemented by any other suitable POS system. In particular for example, the purchase analyzer 104 of the POS terminal 102 is described as implementing the steps of the method; however, any suitable hardware, software, firmware or combinations thereof as components of a computing device or multiple computing device may implements the steps of the method or the functionality described herein for the purchase analyzer 104.

Referring to FIG. 3, the method includes providing 300 a purchase model that indicates identifiers of items for purchase and a likelihood estimate of the identified items being purchased together in a purchase transaction. For example, the purchase analyzer 104 may generate the purchase model 116 and continually update the model to better provide a likelihood that a consumer will purchase 2 or more items together. The purchase model 116 may initially include only identifiers for items carried for purchase in the store. The purchase analyzer 104 may adjust the purchase model 116 based on user input, such as whether or not the customer intended to purchase items together.

The method of FIG. 3 includes using 302 the purchase model to prompt a user about whether purchase was intended for one or more of the items. Continuing the aforementioned example, the purchase analyzer 104 may receive identifiers of items that have been scanned at the POS terminal 102 or otherwise entered in a purchase transaction. Further, the purchase analyzer 104 may determine a likelihood of a purchase of one of the scanned items together with one or more of the other scanned items. In an example, the purchase analyzer 104 may access the purchase model 116 that indicates item identifiers and a likelihood estimate of items being purchased together. The purchase model 116 and database may indicate that there is a 95% likelihood of 2 particular types of hardware being sold together. For example, the purchase model 116 and database may indicate that there is a 95% likelihood of a particular size of bolt, a particular size of nut, and a particular size of washer being sold together. The purchase model 116 may provide a direct comparison between items and indicate the likelihood of the 3 items being sold together. In this example, the 3 different types of hardware may be scanned in a single transaction for a customer. The purchase analyzer 104 may subsequently access the purchase model 116 and database to determine that there is the 95% likelihood of 3 types of hardware being sold together.

Subsequent to prompting the user at step 302, the method of FIG. 3 may include determining 304 whether a customer intended to purchase the item(s). Continuing the aforementioned example, the customer may use the user interface 108 to indicate whether or not he or she intended to purchase one or more of the items. The purchase analyzer 104 may receive the user input. In response to determining that the customer intended to purchase the item(s), the method includes increasing 306, in the purchase model, a likelihood estimate of the item(s) being purchased together. In response to determining that the customer did not intend to purchase the item(s), the method includes decreasing 308, in the purchase model, a likelihood estimate of the item(s) being purchased together.

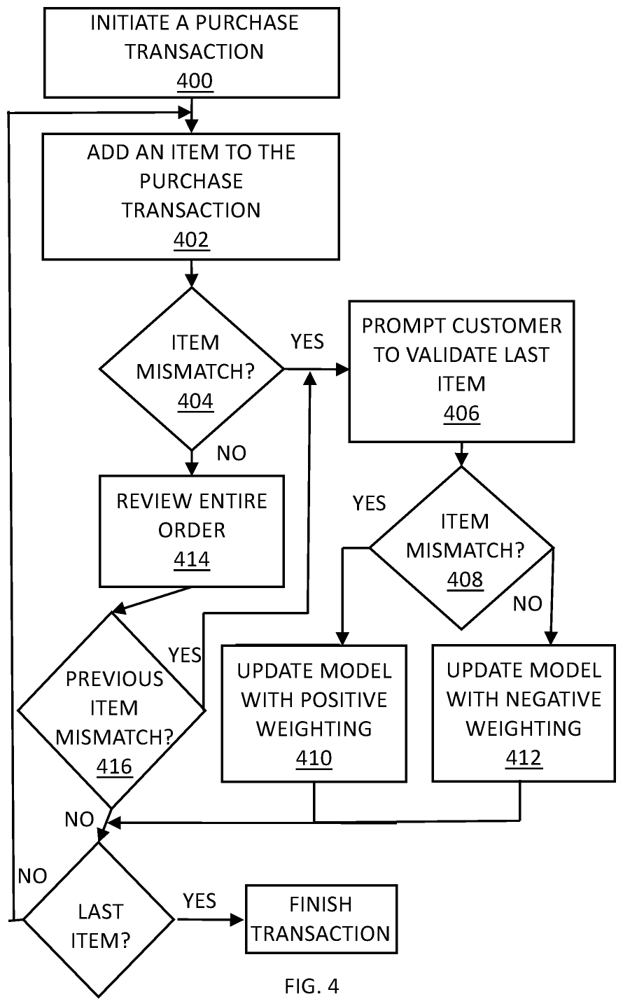

FIG. 4 illustrates a flow chart of another example for determining a likelihood of intended purchase of items and for presenting related information to users in accordance with embodiments of the present disclosure. The method of FIG. 4 is described by example as being implemented by the system 100 shown in FIG. 1, although it should be understood that the method may alternative be implemented by any other suitable POS system. In particular for example, the purchase analyzer 104 of the POS terminal 102 is described as implementing the steps of the method; however, any suitable hardware, software, firmware or combinations thereof as components of a computing device or multiple computing device may implements the steps of the method or the functionality described herein for the purchase analyzer 104.

Referring to FIG. 4, the method includes initiating 400 a purchase transaction. For example, a purchase transaction may be implemented at the POS terminal 102. The purchase transaction may be implemented by a customer's or cashier's interaction with the user interface 108 for starting the purchase transaction. The customer may bring multiple items to the POS terminal 102 for conducting the purchase transaction. The method of FIG. 4 includes adding 402 an item to the purchase transaction. For example, the cashier or customer may use the scanner 106 to scan one of the items to add the item to the purchase transaction.

The method of FIG. 4 includes determining 404 whether the last scanned item is a mismatch. Continuing the aforementioned example, the purchase analyzer 104 may determine a likelihood of the item to be an intended purchased along with other items scanned for the purchase transaction. If the item is determined to be a mismatch, the method may proceed to block 406. Conversely, if the item is determined to not be a mismatch, the method may proceed to block 414.

At block 406 of FIG. 4, the method includes prompting the customer to validate the last item. Continuing the aforementioned example, the purchase analyzer 104 may control the user interface 108 to present (e.g., display) a representation of the last item and query the customer whether purchase of the item was intended. Subsequently, the method includes determining 408 whether there is an item mismatch based on the customer's response to the prompt. For example, the customer may interact with the user interface 108 to indicate a positive (“YES”) or a negative (“NO”) response. If a positive response, the method may include updating 410 a purchase model to more positively weight that the last item with other items is a mismatch. As mentioned above, accumulator C may be incremented in the purchase model 116. Conversely, if a negative response, the method may include updating 410 a purchase model to more negatively weight that the last item with other items is a mismatch. In an example, accumulators E may be incremented in the purchase model 116. Subsequent to steps 410 or 412, the method may return to step 402.

At step 414, the method includes reviewing the entire order. This amounts to re-evaluating all previous items scanned for mismatches given that the most recently added item is not within the same transaction. Further, the method includes determining 416 whether there is a previous item mismatch. For example, in a single transaction, item 1 was regular coffee, item 2 was decaffeinated coffee, and items 3 and 4 were regular coffee. When item 5 is identified as regular coffee, there can be a rule that identifies a 70% likelihood that item 2 is inadvertently being purchased. Hence, item 2 would be identified as a potential mismatch. If the determination is “YES” at step 414, the method proceeds to step 406. If the determination is “NO” at step 414, the method proceeds to step 402.

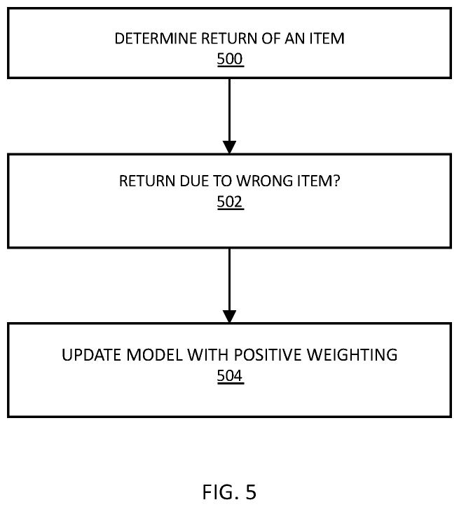

FIG. 5 illustrates a flow chart of an example method for updating a purchase model based on return of an item to a retail store in accordance with embodiments of the present disclosure. The method of FIG. 5 is described by example as being implemented by the system 100 shown in FIG. 1, although it should be understood that the method may alternative be implemented by any other suitable POS system. In particular for example, the purchase analyzer 104 of the POS terminal 102 is described as implementing the steps of the method; however, any suitable hardware, software, firmware or combinations thereof as components of a computing device or multiple computing device may implements the steps of the method or the functionality described herein for the purchase analyzer 104.

Referring to FIG. 5, the method includes determining 500 a return of an item. For example, the purchase analyzer 104 may determine that an item is being returned based on input into the user interface 108. Subsequently, the method includes determining 502 whether the return is due to the item being a wrong item or item the customer did not intend to purchase. Continuing the aforementioned example, this may occur by entry of information into the user interface 108. The method also includes updating 504 a purchase model with a positive weighting in response to it being determined that it is being returned due to the item being a wrong item or item the customer did not intend to purchase. In the purchase model 116, the entire transaction would be evaluated for all applicable rules and the accumulator E would be incremented for all rules. Over a large set of transactions and returns, incrementing E against the wrong rule is self-correcting since C would be incremented if the rule is ever mis-applied in a future transaction.

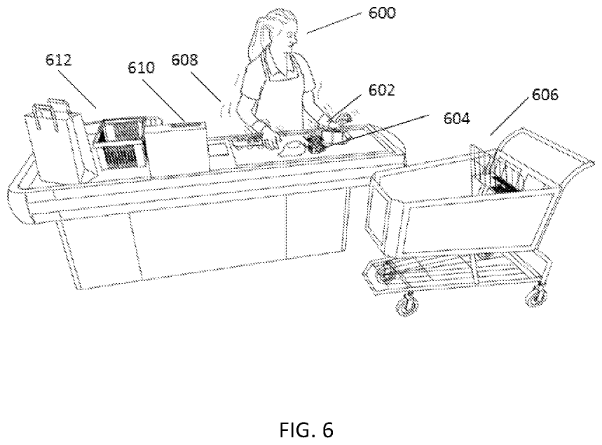

FIG. 6 is a perspective view of an example checkout area with a POS terminal for determining a likelihood of intended purchase of items and for presenting related information to users in accordance with embodiments of the present disclosure. The user 600, as shown in FIG. 6, is a retail employee who is operating a POS terminal 610 during a POS transaction with a bagging area 612 and a shopping cart 606. Although a retail employee is shown, the user 600 may be any individual associated with or directly in contact with a POS transaction. The user 600 may operate the POS terminal 610 and move 602 the items 604 by a scanner for scanning. Further, the POS terminal 610 may be implement the systems and methods disclosed herein for determining a likelihood of intended purchase of items and for presenting related information to users in accordance with embodiments of the present disclosure.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A method comprising:
at a system for conducting purchase transactions:
identifying items selected for purchase;
determining a likelihood of purchase of an item together with one or more of the other items;
presenting, by using a user interface, identification of the item based on the determined likelihood of purchase of the item; and
initiating a purchase transaction for purchase of the identified items.

2. The method of claim 1, further comprising determining whether the determined likelihood exceeds a predetermined threshold, and
wherein presenting identification of the item in response to determining that the determined likelihood exceeds the predetermined threshold.

3. The method of claim 1, further comprising:
receiving a command to delete, from the purchase transaction, the item associated with the presented identification; and
in response to receiving the command, deleting the item from the purchase transaction.

4. The method of claim 1, wherein determining a likelihood of purchase comprises using a purchase model that indicates item identifiers and a likelihood estimate of the identified items being purchased together.

5. The method of claim 4, further comprising:
determining whether a customer intended to purchase the item associated with the presented identification along with the one or more other items; and
changing the purchase model based on the determination of whether the customer intended to purchase the item.

6. The method of claim 5, wherein changing the purchase model comprises increasing the likelihood estimate in response to determining that the customer intended to purchase the item.

7. The method of claim 5, wherein changing the purchase model comprises decreasing the likelihood estimate in response to determining that the customer did not intend to purchase the item.

8. The method of claim 5, further comprising determining whether the customer returned the item associated with the presented identification, and
wherein decreasing the likelihood estimate comprises decreasing the likelihood estimate in response to the customer returning the item.

9. A method comprising:
providing a purchase model that indicates identifiers of items for purchase and a likelihood estimate of the identified items being purchased together in a purchase transaction;
using the purchase model to prompt a user about whether purchase was intended for one or more of the items; and
initiating a purchase transaction for purchase of the identified items.

10. The method of claim 9, wherein using the purchase model comprises using the purchase model to determine a likelihood of purchase of an item together with one or more of the other items, and
wherein the method further comprises presenting identification of the item comprises using a user interface to present identification of the item.

11. The method of claim 10, further comprising:
receiving a command to delete, from a purchase transaction, the item associated with the presented identification; and
in response to receiving the command, deleting the item from the purchase transaction.

12. The method of claim 9, further comprising:
determining whether a customer intended to purchase an item along with other items in a purchase transaction; and
changing the purchase model based on the determination of whether the customer intended to purchase the item.

13. The method of claim 12, wherein changing the purchase model comprises increasing the likelihood estimate in response to determining that the customer intended to purchase the item.

14. The method of claim 12, wherein changing the purchase model comprises decreasing the likelihood estimate in response to determining that the customer did not intend to purchase the item.

15. The method of claim 12, further comprising determining whether the customer returned the item associated with the presented identification, and
wherein decreasing the likelihood estimate comprises decreasing the likelihood estimate in response to the customer returning the item.

16. A system for conducting purchase transactions, the system comprising:
a purchase analyzer configured to:
identify items selected for purchase;
determine a likelihood of purchase of an item together with one or more of the other items;
present identification of the item based on the determined likelihood of purchase of the item; and
initiate a purchase transaction for purchase of the identified items.

17. The system of claim 16, wherein the purchase analyzer is configured to:
determine whether the determined likelihood exceeds a predetermined threshold; and
present identification of the item in response to determining that the determined likelihood exceeds the predetermined threshold.

18. The system of claim 16, wherein the purchase analyzer is configured to:
receive a command to delete, from the purchase transaction, the item associated with the presented identification; and
delete the item from the purchase transaction in response receiving the command.

19. The system of claim 16, wherein the purchase analyzer is configured to use a purchase model that indicates item identifiers and a likelihood estimate of the identified items being purchased together.

20. The system of claim 19, wherein the purchase analyzer is configured to:
determine whether a customer intended to purchase the item associated with the presented identification along with the one or more other items; and
change the purchase model based on the determination of whether the customer intended to purchase the item.

21. The system of claim 20, wherein the purchase analyzer is configured to increase the likelihood estimate in response to determining that the customer intended to purchase the item.

22. The system of claim 20, wherein the purchase analyzer is configured to decrease the likelihood estimate in response to determining that the customer did not intend to purchase the item.

23. The system of claim 20, wherein the purchase analyzer is configured to:
determine whether the customer returned the item associated with the presented identification; and
decrease the likelihood estimate in response to the customer returning the item.

24. A system comprising:
a purchase analyzer configured to:
provide a purchase model that indicates identifiers of items for purchase and a likelihood estimate of the identified items being purchased together in a purchase transaction;
use the purchase model to prompt a user about whether purchase was intended for one or more of the items; and
initiate a purchase transaction for purchase of the identified items.

25. The system of claim 24, wherein the purchase analyzer is configured to:
use the purchase model to determine a likelihood of purchase of an item together with one or more of the other items; and
present identification of the item comprises using a user interface to present identification of the item.

26. The system of claim 24, wherein the purchase analyzer is configured to:
receive a command to delete, from a purchase transaction, the item associated with the presented identification; and
delete the item from the purchase transaction in response to receiving the command.

27. The system of claim 24, wherein the purchase analyzer is configured to:
determine whether a customer intended to purchase an item along with other items in a purchase transaction; and
change the purchase model based on the determination of whether the customer intended to purchase the item.

28. The system of claim 27, wherein the purchase analyzer is configured to increase the likelihood estimate in response to determining that the customer intended to purchase the item.

29. The system of claim 27, wherein the purchase analyzer is configured to decrease the likelihood estimate in response to determining that the customer did not intend to purchase the item.

30. The system of claim 27, wherein the purchase analyzer is configured to:
determine whether the customer returned the item associated with the presented identification; and
decrease the likelihood estimate in response to the customer returning the item.
